(19) United States
(12) Patent Application Publication
(10) Pub. No.: US 2026/0255345 A1
(43) Pub. Date: Aug. 27, 2026

(54) METHODS FOR DETERMINING UTO REFERENCE WINDOWS

(71) Applicant: Telefonaktiebolaget LM Ericsson (publ), Stockholm (SE)

(72) Inventors: Jonas FRÖBERG OLSSON, Ljungsbro (SE); Bikramjit SINGH, Raasepori (FI); Ying SUN, Täby (SE); Robert KARLSSON, Sundbyberg (SE); Sorour FALAHATI, Stockholm (SE)

(73) Assignee: Telefonaktiebolaget LM Ericsson (publ), Stockholm (SE)

(21) Appl. No.: 19/472,836

(22) PCT Filed: Apr. 8, 2024
(86) PCT No.: PCT/IB2024/053435

§ 371 Date: Oct. 6, 2025

Related U.S. Application Data
(60) Provisional application No. 63/457,880, filed on Apr. 7, 2023.

(51) Int. Cl. H04W 72/1268

(52) U.S. Cl. CPC H04W 72/1268

(57) ABSTRACT

A method performed by a UE in a wireless communication network includes receiving a configured grant (CG) configuration, wherein a plurality of transmission occasions (TOs) are referenced in the CG configuration, transmitting to a network node an unused TO (UTO) indicator for the CG configuration that indicates that one or more of the TOs referenced in the CG configuration will be unused, transmitting to the network node an indicator that indicates a time window during which the UTO indicator is valid, and transmitting to the network node an uplink signal during a TO referenced in the CG configuration in accordance with the UTO indicator during the time window. Related network node embodiments are disclosed.

### RELATED APPLICATIONS

The present application claims priority to and the benefit of U.S. Provisional Patent Application No. 63/457,880, filed on Apr. 7, 2023, which is hereby incorporated by reference in its entirety.

### TECHNICAL FIELD

The present disclosure relates to wireless communication networks, and in particular to the use of configured grants for uplink transmissions in wireless communication networks.

### BACKGROUND

In the ongoing Rel-18 study item on extended Reality (XR), several enhancements are being proposed to increase XR capacity of 5G-Advanced systems.

eXtended Reality (XR), XR includes services provided by computer technologies and wearables that allow for human-machine interaction in real/virtual mixed environments. XR includes Virtual Reality (VR), Augmented Reality (AR), Mixed Reality (MR), Cloud Gaming, and the areas interpolated among them. As such, XR is usually considered a mixed eMBB/URLLC service. As noted in Table 1, XR traffic is a mixture of heterogeneous uplink (UL)/downlink (DL) data flows, including video, audio, and control traffic.

TABLE 1
XR traffic characteristics and requirements identified by 3GPP.

| | | Data | Packet (frame) | Packet Delay |
|---|---|---|---|---|
| | | rate [Mbps] | rate [fps] | Budget (PDB) [ms] |
| DL | AR/VR Video | 30 | 60 | 10 |
| | Cloud Gaming | 30 | 60 | 15 |
| UL | Pose/control | 0.2 | 250 | 10 |
| | Video (Scene) | 10 | 60 | 30 |

Table 1 highlights that XR traffic flows have different characteristics (e.g., packet rate in frame per second [fps] and bit rate in bit per second [bps]) and requirements in terms of (application) packet delay budget (PDB) [ms]. Among XR flows, DL video and UL scene traffic are periodic (with possible jitter particularly in DL) and have variable large-sized application packets.

### Configured Grant

The information element (IE) ConfiguredGrantConfig is used to configure uplink transmission without a dynamic grant according to two possible schemes. The actual uplink grant may either be configured via radio resource control (RRC) (type1) or provided via the physical downlink control channel (PDCCH) (type2). Multiple Configured Grant configurations may be configured in one bandwidth part (BWP) of a serving cell.

For both Type 1 and Type 2 configured grant, a user equipment (UE) is provided time-frequency resources on which the UE is allowed to transmit a physical uplink shared channel (PUSCH). The time-frequency resources where UE is allowed to transmit PUSCH is herein referred to as Transmission Occasions (TOs).

For Type 1 configured grant the time-frequency resources are indicated using the parameters timeDomainAllocation, frequencyDomainAllocation and periodicity together with a time reference to the slot in which the TO is located indicated in a RRC message. The periodicity indicates recurrence of the TOs. The timeDomainAllocation parameter indicates the first symbol of the PUSCH and the duration of the PUSCH (in symbols) and the frequencyDomainAllocation parameter indicates the Resource Blocks (RBs) used by the PUSCH. For example, the timeDomainAllocation parameter may indicate startSymbol=0 and endSymbol=14 (the PUSCH start in the first symbol of the slot and ends in the last symbol) and the time reference may indicate that first TO is in slot 4. If the periodicity is 5 slots, then TOs for the configured grant would be present in the slots 4, 9, 14, 19, 24, . . . . Once the UE has been configured with Type 1 configured grant, the UE may or may transmit a PUSCH on the TOs for the configured grant until UE receives a RRC message disabling the configured grant.

Type 2 configured grant is more flexible than Type 1 configured grant. In a Type 2 configured grant, the UE is provided the periodicity of the configured grant is provided by RRC. The timeDomainAllocation and frequencyDomainAllocation parameters are provided via PDCCH, which simultaneously activates the configured grant. The timeDomainAllocation parameter together when the activation downlink control information (DCI) on PDCCH is sent to UE gives the time reference for first TO. The Type 2 configured grant can be deactivated by a deactivation DCI on a PDCCH.

The medium access control (MAC) entity may be configured to skip uplink transmission if the transport block will be empty (or only contain low priority data). In that case, the MAC entity will not generate a MAC protocol data unit (PDU) and the MAC entity will not deliver a grant to the hybrid automatic repeat request (HARQ) entity and the HARQ entity will not trigger a transmission.

### SUMMARY

A method performed by a UE in a wireless communication network according to some embodiments includes receiving a configured grant (CG) configuration, wherein a plurality of transmission occasions (TOs) are referenced in the CG configuration, transmitting to a network node an unused TO (UTO) indicator for the CG configuration that indicates that one or more of the TOs referenced in the CG configuration will be unused, transmitting to the network node an indicator that indicates a time window during which the UTO indicator is valid, and transmitting to the network node an uplink signal during a TO referenced in the CG configuration in accordance with the UTO indicator during the time window.

A method performed by a network node in a wireless communication network according to some embodiments includes configuring a user equipment, UE, with a CG configuration, wherein a plurality of TOs, are referenced in the CG configuration, receiving from the UE a UTO indicator for the CG configuration that indicates that one or more of the TOs referenced in the CG configuration will be unused, receiving from the UE an indicator that indicates a time window during which the UTO indicator is valid, and receiving from the UE an uplink signal during a TO referenced in the CG configuration in accordance with the UTO indicator during the time window.

The time window may be indicated as [T+W1, T+W2], where T is a reference time and 0<=W1<=W2. The time window may be configured by the network nod, and/or may be selected or altered by the UE.

The reference time may include a time when the indicator that indicates the time window is transmitted.

The reference time may be indicated with the indicator that indicates the time window.

The UTO indicator may include a bitmap of TOs referenced in the CG configuration.

### BRIEF DESCRIPTION OF THE DRAWINGS

FIG. 1 illustrates serving XR traffic using CG on a TDD carrier with a DDDUU pattern and 30 kHz sub-carrier spacing.

FIG. 2 illustrates UTO indicators according to some embodiments.

FIG. 3 illustrates sending UTO indicators in windows according to some embodiments.

FIG. 4 illustrates reference windows for UTO indicators according to some embodiments.

FIG. 5 illustrates a method performed by a UE in a wireless communication network according to some embodiments.

FIG. 6 illustrates a method performed by a network node in a wireless communication network according to some embodiments.

FIG. 7 shows an example of a communication system in accordance with some embodiments.

FIG. 8 shows a UE in accordance with some embodiments.

FIG. 9 shows a network node in accordance with some embodiments.

FIG. 10 is a block diagram of a host in accordance with some embodiments.

FIG. 11 is a block diagram illustrating a virtualization environment in which functions implemented by some embodiments may be virtualized.

FIG. 12 shows a communication diagram of a host communicating via a network node with a UE over a partially wireless connection in accordance with some embodiments.

### DETAILED DESCRIPTION

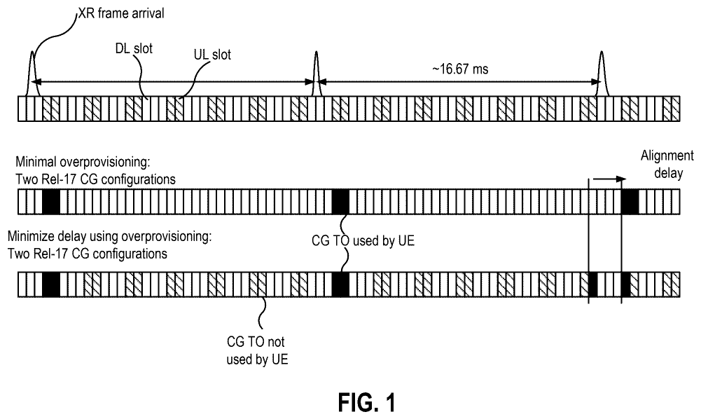

There currently exist certain challenge(s). A problem with using configured grant (CG) is that XR frame rates result in non-integer periodicity, e.g., 60 frames/second≈16.67 ms, which makes it difficult or impossible to perfectly align CG Transmission Occasions (TOs) with the arrival of an XR frame. This becomes especially difficult on time division duplex (TDD) carriers. When utilizing CG to serve XR traffic, the gNB often needs to overprovision CG resources to meet the latency requirements. This may result in inefficient resource utilization due to overprovisioning of configured grant resources as illustrated in FIG. 1, which illustrates serving XR traffic using CG on a TDD carrier with a DDDUU pattern and 30 kHz sub-carrier spacing (SCS).

In the XR WID (XR Work Item Description) for R18 it has been agreed to include an objective to solve the over provisioning problem and improve XR capacity, when CG is used to serve XR traffic by enabling the UE to dynamically indicate unused CG PUSCH occasion(s) based on uplink control information (UCI) to the gNB. In particular it has been agreed to specify enhancements related to capacity, including dynamic indication of unused CG PUSCH occasion(s) based on uplink control information (UCI) by the UE (RAN1).

It was further agreed to specify enhancements related to multiple CG PUSCH transmission occasions in a period of a single CG PUSCH configuration (RAN1, RAN2), buffer status reporting (BSR) enhancements including at least new buffer status (BS) Table(s) (RAN2), delay reporting of buffered data in uplink (RAN2), provision of XR traffic assistance information for DL and UL (e.g. periodicity) (RAN2), and discard operation of PDU Sets (RAN2).

As part of the feature design, methods to determine the content of the UCI such that it can serve the intended purpose, are needed.

At RAN1 #112 meeting the agreements shown in Table 2 were made.

TABLE 2
RAN1#112 Agreements

```
Agreement
The physical channel that carries the UCI that provides information about unused CG PUSCH
transmission occasions is CG PUSCH.
Agreement
Encoding and multiplexing for “the UCI that provides information about unused CG PUSCH
transmission occasions” in a CG PUSCH applies encoding and multiplexing procedures for
CG-UCI as baseline.
    FFS on details
Agreement
Consider the following alternatives for “the UCI that provides information about unused CG
PUSCH transmission occasions” for down-selection or revision
    Alt. 1: “The UCI that provides information about unused CG PUSCH transmission
    occasions” is defined as a new UCI.
        FFS on details
    Alt. 2: “The UCI that provides information about unused CG PUSCH transmission
    occasions” is added as new field(s) to the CG-UCI.
        FFS on details
    Alt. 3: “The UCI that provides information about unused CG PUSCH transmission
    occasions” replaces/re-purposes some field(s) of the CG-UCI.
        FFS on details
Agreement
For dynamic indication of unused CG PUSCH occasion(s) based on a UCI, the following options
for further down-scoping with possible revision, are considered for the transmission occasion of
the UCI:
  Option 1: A transmitted CG PUSCH, includes the UCI.
      FFS details
  Option 2: A transmitted CG PUSCH includes the UCI, if it is transmitted in an occasion
  determined by RRC.
      FFS details
  Option 3: A transmitted CG PUSCH includes the UCI, if it is transmitted in a pre-defined
  transmission occasion.
      FFS details
          Example of a pre-determined occasion: 1^{st} configured PUSCH TO in a CG
          period or 1^{st} configured PUSCH TO in a multiple CG periods
  Option 4: A transmitted CG PUSCH includes the UCI, if it is transmitted in a transmission
  occasion determined satisfying given condition(s).
      FFS details
          Examples of a condition: A first transmitted PUSCH in a CG period, or a
          first PUSCH transmission within a multiple of CG periods.
Other options are not precluded. Proponent companies to provide details.
Agreement
For dynamic indication of unused CG PUSCH transmission occasion(s) based on a UCI, the
following options for further down-scoping, are considered for the information provided by the
UCI:
  Option 1: The UCI determines the consecutive CG PUSCH TO(s) that are indicated as
  “unused”
      Option 1-1: The UCI provides the number of consecutive TO(s) in time domain.
          Applicable numbers can be determined from information obtained from
          configuration.
          FFS details
      Option 1-2: The UCI provides a time duration/range that includes the consecutive
      TO(s) in time domain.
          Applicable time duration/range can be determined from information
          obtained from configuration
          FFS details
  Option 2: The UCI determines the CG PUSCH TO(s) that are indicated as “unused”
  (consecutive/non-consecutive TO(s) in time domain)
      Option 2-1: The UCI provides a bitmap where a bit corresponds to a TO within a
      time duration/range. The bit indicates whether the TO is “unused”.
          Applicable time duration/range can be determined from information
          obtained from configuration
          FFS details
      Option 2-2: The UCI provides a bitmap where a bit corresponds to TOs within a
      time duration/range. The bit indicates whether all TOs within the time
      duration/range are “unused”.
          Applicable time duration/range can be determined from information
          obtained from configuration
          FFS details
  FFS whether/how the unused TO(s) can be associated to multiple CG configuration.
  Other options are not precluded. Proponent companies to provide details.
```

Certain aspects of the disclosure and their embodiments may provide solutions to these or other challenges. In particular, some embodiments provide methods for determining a window for referencing one or more configured grant transmission occasions as unused.

Certain embodiments may provide one or more of the following technical advantage(s). In particular, some embodiments described herein may enable the referenced configured grant transmission occasions in Unused Transmission Occasions (UTO) indication to be defined within a foreseeable timeframe.

Some of the embodiments contemplated herein will now be described more fully with reference to the accompanying drawings. Embodiments are provided by way of example to convey the scope of the subject matter to those skilled in the art. Additional information may also be found in the document(s) provided in the Appendix.

In the embodiments described herein, functionality is applied based on indicating ‘un-used’ TOs using RRC, physical layer (PHY), and other higher layer configurations. However, the same embodiments can be utilized to indicate ‘used’ TOs, instead of un-used TOs. For instance, if a UCI indicating subset of un-used TOs (in below embodiments), the concept in the embodiments can be used to reinterpret or repurpose the functionality to indicate ‘used’ TOs from the group/plurality of TOs, because:

$$‘ used TOs set ’ = ‘ plurality / group of TOs set ’ MINUS ‘ un - used TOs set ’ .$$

Embodiments described herein may be combined to longer periods of used and unused TOs. For example, the UE may indicate some TOs as unused, some other TOs as used and then some TOs as unused (in a detailed example with three consecutive time periods T1, T2 and T3, the UE may indicate the TOs in T1 and T3 as unused, while the TOs in T2 as used, or vice versa the UE may indicate that the TOs in T1 and T3 are used while the TOs in T2 are unused).

In some embodiments, “configured uplink grant transmission”, “CG TOs”, “PUSCH duration of configured grant”, “configured grant PUSCH”, “PUSCH is correspond to a configured grant,” etc., are various ways to express reference a transmission occasion where UE may transmit a PUSCH associated/assigned by a configured grant. Furthermore, in MAC specification a configured grant is considered to “reoccur” or “sequentially occur” (See Clause 5.8.2 of [2]).

The reoccurring and sequentially occurring is sometimes viewed as that there are multiple TOs associated with a configured grant and sometimes viewed as that a reoccurring or sequentially occurring uplink (configured) grant.

In some embodiments, alternative to the embodiments below, a ‘slot’ may be a sub-slot or “transmission unit”.

The term TO can be synonymous to configured PUSCH, or TB resource.

A UE may be configured with multiple CG configurations. The CG configurations may be associated to the same or different cells/carriers, or to the same or different BWP associated to the same or different cells/carriers. In some embodiments described below, when multiple CG configurations are referred to different carriers, the methods are applicable even if the multiple CG configurations are associated to the same or different cells/carriers, or to the same or different BWP associated to the same or different cells/carriers, unless explicitly stated.

In some embodiments, the UE is configured with a configured grant (CG) with multiple TOs, where the UE may transmit a PUSCH on each TO. TOs are referenced herein as TO₁, TO₂, . . . . To each of the TOs there are time instances t₁, t₂, . . . corresponding the start time of the TO. At a time T₁ the UE transmitted a first UTO (Unused TO) indicator indicating a sub-set S₁={TOᵢ_{₁}, TOᵢ_{₂}, . . . , TOᵢ_{₁}} of the TOs to be “unused”, where a TO indicated as “unused” is understood as an indication from the UE that it will not perform a PUSCH on the TO. At a later time T₂>T₁ the UE transmits a second UTO (Unused TO) indicator indicating a sub-set S₂={TOⱼ_{₁}, TOⱼ_{₂}, . . . , TOⱼ_{ⱼ}} of the TOs to be “unused”. A set S of TOs may also be defined in terms of time periods, that is, S may be a period from time t₁ to time t₂ and each TO that occur in this time period belongs to the set S, then the TOs in set S may be indicated to be used or unused.

In some embodiments, if TOₖ does not belong to S₁, then UE may or may not include TOₖ in S₂ without restrictions. That is, if TOₖ was not indicated as “unused” by first UTO indicator, the UE may or may not indicate TOₖ as “unused” by second UTO indicator.

### Window Size of Unused TOs

A UTO indicator transmitted at time T is assumed to reference a TOₖ if start time tₖ fulfills T+W₁≤tₖ≤T+W₂ where 0≤W₁≤W₂. That is, the start time of TOₖ is inside a reference window [T+W₁, T+W₂].

A UTO indicator transmitted at time T is assumed to reference a TOₖ if start time tₖ fulfills T+W₁≤tₖ≤T+W₂ where 0≤W₁<W₂. That is, the start time of TOₖ is inside a reference window [T+W₁, T+W₂].

In one embodiment the reference size W₂−W₁ or parameters [T+W₁, T+W₂] w.r.t. time T is defined by gNB, which can be indicated in some RRC/MAC CE/L1 signaling. In other words, the gNB can define minimum time, where the window starts or can start, i.e., W₁ after time T and the maximum time (where window ends), i.e., W₂ after time T. It means the UTO sent at time T cannot indicate unused TOs before time T+W₁ or after time T+W₂. In an extended embodiment, the gNB/network (alternatively a fixed window or a window selection algorithm may be hard coded in the specification) can allow UE to select different say [T+W₁₁, T+W₂₂] autonomously, however, gNB can specify some rules pertinent to autonomous window selection. In one rule.
The minimum time of the start time of the autonomous window W₁₁ should be greater than or equal to gNB/network defined minimum time for the start time of window W₁, i.e., W₁₁≥W₁.
The maximum time for the end time of autonomous window W₂₂ should be less than or equal to gNB/network defined maximum time for the end time of window W₁, i.e., W₂₂≤W₂

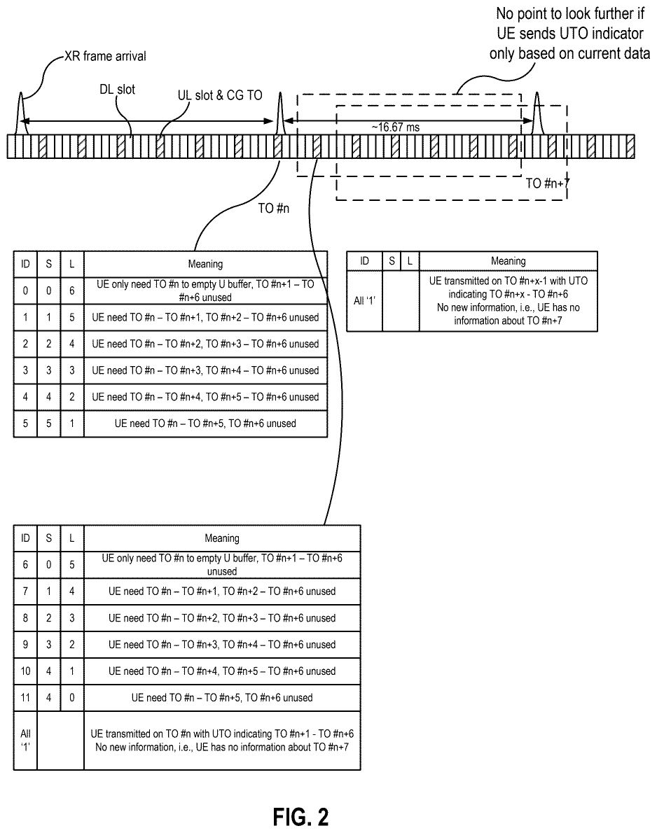

In one embodiment, the window end W₂ is determined by the UTO indicator. For example, the UTO indicators may be as illustrated in FIG. 2. In the table, “ID” is the identity/index indicated by the UTO indicator, “S” is the start TO offset from the TO after the TO in which the UTO indicator is transmitted. “L” is the length of the UTO patten. For example, a UTO indicator transmitted in TO #n+1 and indicating the ID=6 would indicate that UE would not use TO #n+2−TO #n+6.

The “all ‘1’” UTO indicator has the meaning that UE cannot provide gNB with new information. For example, if UE did not transmit CG PUSCH on TO #n−1 but transmit CG PUSCH and UTO indicator in TO #n+1 then UE would transmit UTO indicator as one of ID 7-12 and if UE transmit a CG PUSCH on TO #n+x, x=2, 3 . . . , 6 the UE would transmit the “all ‘1’” UTO indicator to indicate that UE has no new information for TO #n+7 and beyond. Effectively, this means that the window end W₂ depends on in which TO the UE transmits the UTO indicator. Note that in this example it is assumed that gNB knows that UE would never need more than 6 TOs to transmit a XR frame. If gNB would expect UE to need more TOs, the gNB may configured with more IDs for the UTO indicator.

It should be clear for a person skilled in the art that “all ‘1’” could be replaced by “all ‘0’” or any other ID as “special ID” by proper re-arrangement of the IDs.

In alternative embodiment, the UTO indicator indicates a bitmap of TOs as shown, for example in Table 3. For example, ID 1 could be indicated as ‘011111’ and ID 7 could be indicated as ‘01111’. It could be noticed that the lengths of the bitmaps are different. Implementation-wise this could be achieved such that for each ID there is bitmap of X bits but also parameter indicating W₂. The UTO indicator table in Table 4 could be replaced by (the all ‘1’ ID is excluded). For the IDs with W₂=5 the last bit is indicated as ‘X’ since it has no meaning.

TABLE 3
UTO Indicator Table

| ID | Bitmap (6 bits) | W₂ |
|---|---|---|
| 0 | 111111 | 6 |
| 1 | 011111 | 6 |
| 2 | 001111 | 6 |
| 3 | 000111 | 6 |
| 4 | 000011 | 6 |
| 5 | 000001 | 6 |
| 6 | 11111X | 5 |
| 7 | 01111X | 5 |
| 8 | 00111X | 5 |
| 9 | 00011X | 5 |
| 10 | 00001X | 5 |
| 11 | 00000X | 5 |

In yet another embodiment, the gNB may provide the UE with all possible options with different length of the window. For example, in above example there are at most 6 TOs between two consecutive XR frame arrivals and gNB may provide the UE with UTO ID as shown in Table 4 (bits beyond the indicated window is excluded). In such embodiments, there need not to be a special interpretation of all ‘1’ ID.

TABLE 4
UTO Indicator Table

| ID | Bitmap (6 bits) | W₂ |
|---|---|---|
| 0 | 111111 | 6 |
| 1 | 011111 | 6 |
| 2 | 001111 | 6 |
| 3 | 000111 | 6 |
| 4 | 000011 | 6 |
| 5 | 000001 | 6 |
| 6 | 000000 | 6 |
| 7 | 11111 | 5 |
| 8 | 01111 | 5 |
| 9 | 00111 | 5 |
| 10 | 00011 | 5 |
| 11 | 00001 | 5 |
| 12 | 00000 | 5 |
| 13 | 1111 | 4 |
| 14 | 0111 | 4 |
| 15 | 0011 | 4 |
| 16 | 0001 | 4 |
| 17 | 0000 | 4 |
| 18 | 111 | 3 |
| 19 | 011 | 3 |
| 20 | 001 | 3 |
| 21 | 000 | 3 |
| 22 | 11 | 2 |
| 23 | 01 | 2 |
| 24 | 00 | 2 |
| 25 | 1 | 1 |
| 26 | 0 | 1 |

Alternative to the special all ‘1’ ID, gNB may configure the UE with an ID=27 with W₂=0 which UE can use if UE can provide gNB with any information if future TOs will be used or not.

In embodiments where UTO indicator may indicate a variable W₂, if UE transmitted a first UTO indicator at time T then UE transmits a second UTO indicator at the first TO (where UE transmits CG PUSCH) if the start time of said TO starts after T+W₂ and does not transmit UTO indicator in CG PUSCHs transmitted on TOs starting between [T, T+W₂].

In some embodiments, the UE is configured with a “padding threshold” such as UE shall indicate a TO as “unused” if the amount of padding (e.g. the size of MAC padding PDUs) in the MAC PDU would exceed the “padding threshold”. This may be beneficial if UE is provided with all possible options for the UTO indicator for different lengths of the window to avoid UE to indicate a TO as “not unused” although the CG PUSCH only contained very small amount of data.

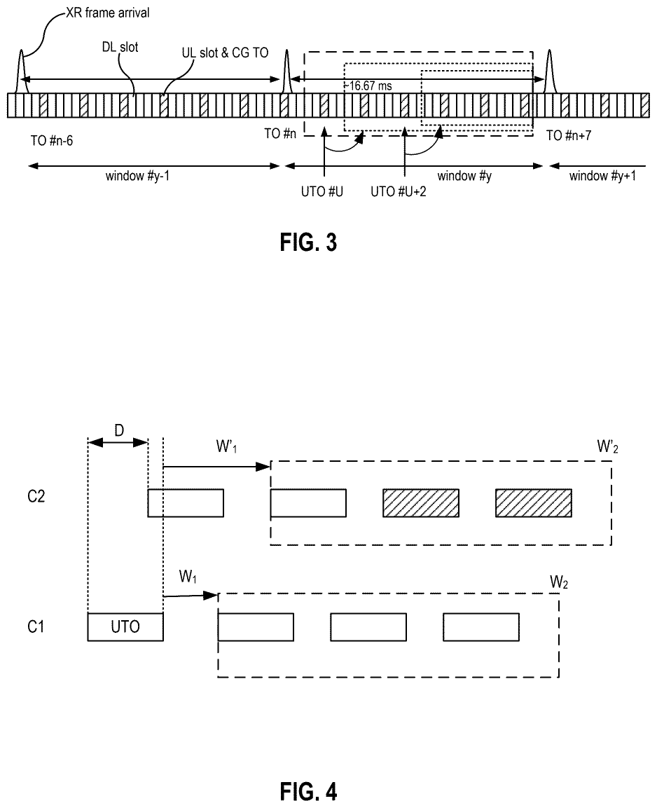

In some embodiments, the end of the window set before/at the next arrival. It means, if some XR awareness is available at gNB or UE (exchanged with gNB/network), the UTO sent to indicate unused TOs always occur between the two arrivals (i.e., indicated TOs located between the current arrival and before the next arrival or current window), or the window size is set between the consecutive two arrivals. Say, if a UTO sent in window #y (see FIG. 3), then it provides indication for TOs which are after the UTO in window y (not in window y+1) until the end of its window. This is because, if we set the end of the window after the next arrival, then we do not know the data volume in next arrival (as it has not come yet in the buffer), therefore, UE cannot indicate with certainty if the TOs in future (which are after the next arrival) will be needed/used or not.

In some embodiments, if UE includes TO (indicated in UTO) which are after next arrival (next window), then gNB can ignore the UTO indication for such TOs, as UE has not received the data for that future arrival in UE's buffer, so such indication may be deemed improper. However, in the UTO, the indication related to TOs from the current window/arrival (related to TOs after the current arrival) is considered as the indication may be based on actual data buffered from the current arrival. In embodiment, XR awareness can be made available at UE, where it can use XR traffic related information from its application/higher layer, or it can fetch the information from gNB/network/5GC. In one embodiment, the gNB/network can gain the XR awareness knowledge by fetching the information from UE using various signaling (control/NAS/RRC/MAC). Also, gNB and UE can gain XR awareness using statistical knowledge, i.e., the node can record the arrivals, and try to model and understand its periodicity, jitter, variance, average size of the arrival, etc.

### Multiple CGs

In some embodiments, the UE is configured with multiple CG configurations (in one or more BWPs belonging to one or more serving cells) and further configured to transmit the UTO indicator indicating unused TOs for two or more out of the multiple CG configurations. In some such embodiments, at least two of the two or more out of the multiple CG configurations have TOs on different carriers. In some such embodiments, the UTO indicator comprises one UTO indicator for each of the two or more out of the multiple CG configurations. For example, let k be the number of at least two out of the multiple CG configurations, then the UTO indicator may be comprised as k-tuple [UTO #1, UTO #2, . . . , UTO #k], where UTO #i, i=1, 2, . . . , k is the UTO indicator for CG configuration of the i-th CG configuration of k CG configurations.

In some embodiments, the end W₂ of the reference window may be common or different for some of the said k CG configurations. For example, if the k CG configurations are on k carriers the carriers with same numerology may share the same W₂ while carriers with different numerology have different W₂. As in previous embodiments the W₂ may be implicit from the start S and length L or explicitly defined by a configuration parameter.

In some embodiments, end W₂ of the reference window may defined in a reference numerology and W₂ for a carrier is deduced from the carrier's numerology and the reference numerology. For example, let W₂=2 and the reference numerology is μ, then

$${W}_{2}^{′}$$

for a carrier with numerology μ′ would equal:

$${W}_{2}^{′} = \frac{{2}^{{μ}^{′}}}{{2}^{μ}} {W}_{2} .$$

In further other examples, W′₂ may depend further on a reference CG periodicity P where:

$${W}_{2}^{′} = \frac{{2}^{{μ}^{′}}}{{2}^{μ}} \cdot \frac{P}{{P}^{′}} {W}_{2} ,$$

where P′ is the periodicity of the CG configuration on the carrier with numerology μ′. For example, if μ=1, P=1, μ′=2, P′=2 and W₂=2 then

$${W}_{2}^{′} = 2$$

as well, i.e. the reference window would “cover” both the same time duration and same number of TOs.

In some embodiments, the start W₁ of the reference window may be common or different for some of the said k CG configurations. For example, the same formulas as for W₂ may apply. In another example, if the UTO indicator is transmitted at time T (start or end symbol of CG PUSCH that carries the UTO indicator) on a first carrier referencing TOs on a first and second carrier, W₁ may be applied for first carrier while

$${W}_{1}^{′}$$

is applied for second carrier. If the two carriers are un-synchronized,

$${W}_{1}^{′}$$

may be determined as

$${W}_{1}^{′} = {W}_{1} + Δ ,$$

where Δ is a synchronization offset between first and second carrier as illustrated in FIG. 4.

In some embodiments in which multiple CG configurations are configured, the UTO indicates time periods for unused or used TOs. All TOs within the time period in all CG configurations (across cells and across BWPs) are then used or unused.

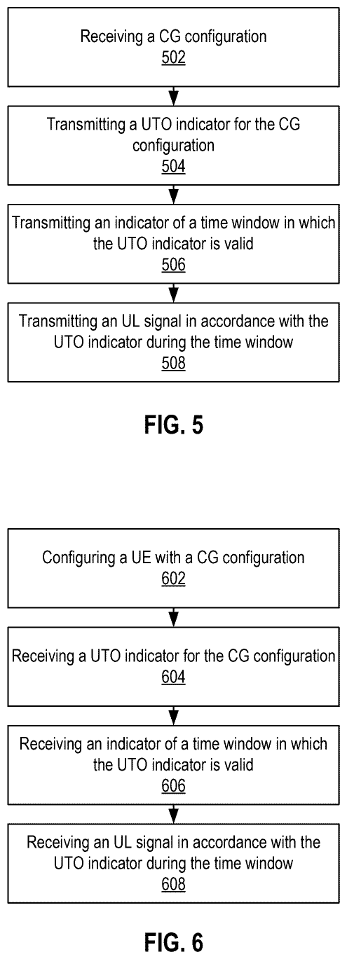

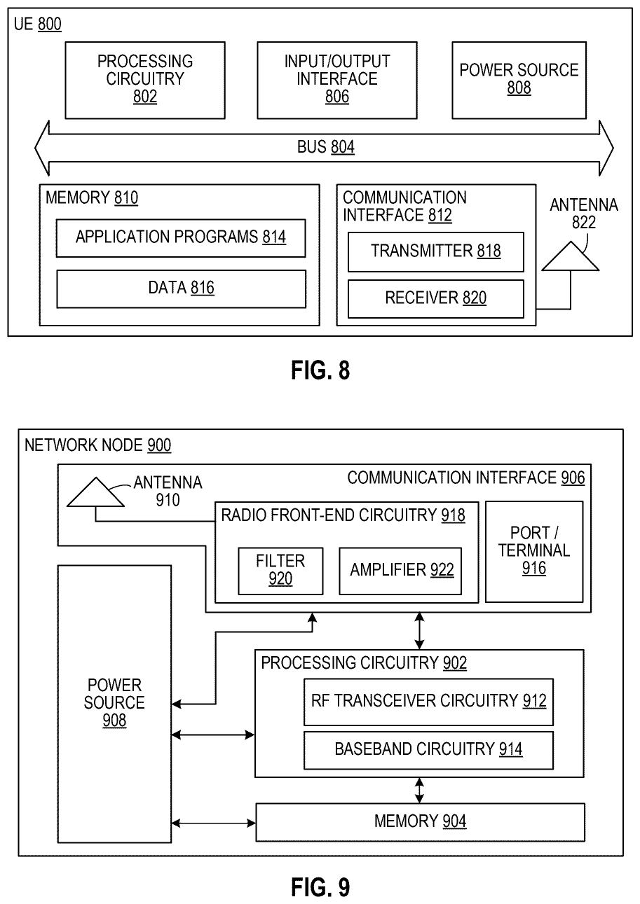

FIG. 5 illustrates a method performed by a user equipment, UE, in a wireless communication network, such as a UE 800 illustrated in FIG. 8. The method includes receiving (502) a configured grant, CG, configuration, wherein a plurality of transmission occasions, TOs, are referenced in the CG configuration; transmitting (504) to a network node 900 (FIG. 9) an unused TO, UTO, indicator for the CG configuration that indicates that one or more of the TOs referenced in the CG configuration will be unused; transmitting (506) to the network node 900 an indicator that indicates a time window during which the UTO indicator is valid; and transmitting (508) to the network node 900 an uplink signal during a TO referenced in the CG configuration in accordance with the UTO indicator during the time window.

FIG. 6 illustrates a method performed by a network node in a wireless communication network, such as a network node 900 illustrated in FIG. 9. The method includes configuring (602) a UE 800 with a CG configuration, wherein a plurality of TOs are referenced in the CG configuration; receiving (604) from the UE a UTO indicator for the CG configuration that indicates that one or more of the TOs referenced in the CG configuration will be unused; receiving (606) from the UE an indicator that indicates a time window during which the UTO indicator is valid; and receiving (608) from the UE an uplink signal during a TO referenced in the CG configuration in accordance with the UTO indicator during the time window.

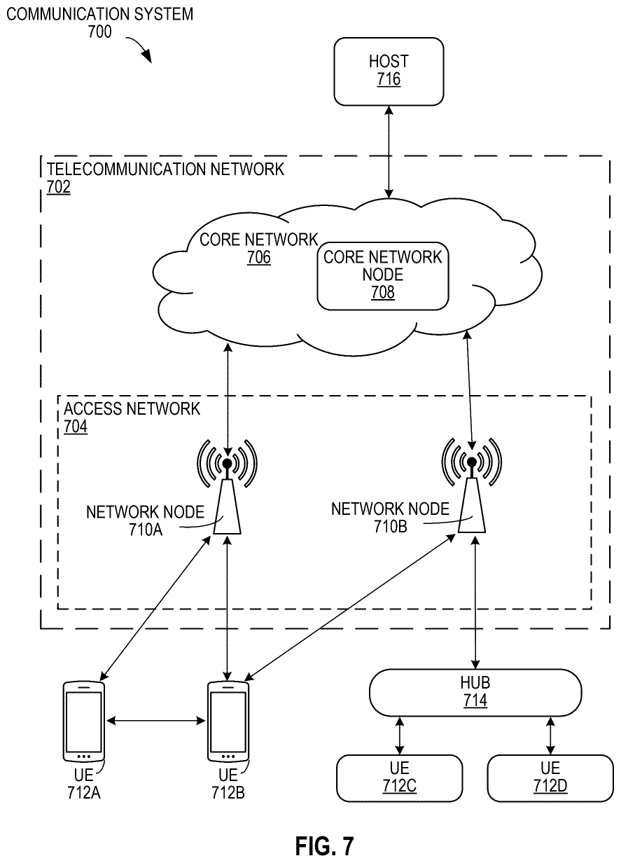

FIG. 7 shows an example of a communication system 700 in accordance with some embodiments.

In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 702 includes one or more Open-RAN (ORAN) network nodes. An ORAN network node is a node in the telecommunication network 702 that supports an ORAN specification (e.g., a specification published by the O-RAN Alliance, or any similar organization) and may operate alone or together with other nodes to implement one or more functionalities of any node in the telecommunication network 702, including one or more network nodes 710 and/or core network nodes 708.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710b. In other embodiments, the hub 714 may be a non-dedicated hub—that is, a device which is capable of operating to route communications between the UEs and network node 710b, but which is additionally capable of operating as a communication start and/or end point for certain data channels.

FIG. 8 shows a UE 800 in accordance with some embodiments. As used herein, a UE refers to a device capable, configured, arranged and/or operable to communicate wirelessly with network nodes and/or other UEs. For example, the UE 800 may be configured to perform the operations illustrated in and described in connection with FIG. 5. Examples of a UE 800 include a VR or AR device, such as an head-mounted display. Other example include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle-embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display (HMD) for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node 900 in accordance with some embodiments. For example, the network node 900 may be configured to perform the operations illustrated in and described in connection with FIG. 6. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

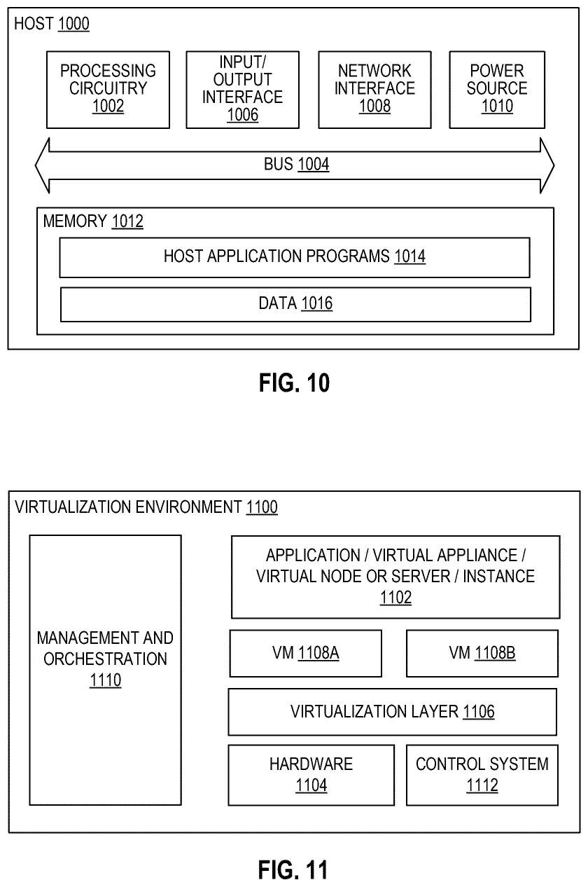

FIG. 10 is a block diagram of a host 1000, which may be an embodiment of the host 716 of FIG. 7, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs, such as an AR/VR game or application.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such as FIGS. 8 and 9, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1100 includes components defined by the O-RAN Alliance, such as an O-Cloud environment orchestrated by a Service Management and Orchestration Framework via an O-2 interface.

Applications 1102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g. such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

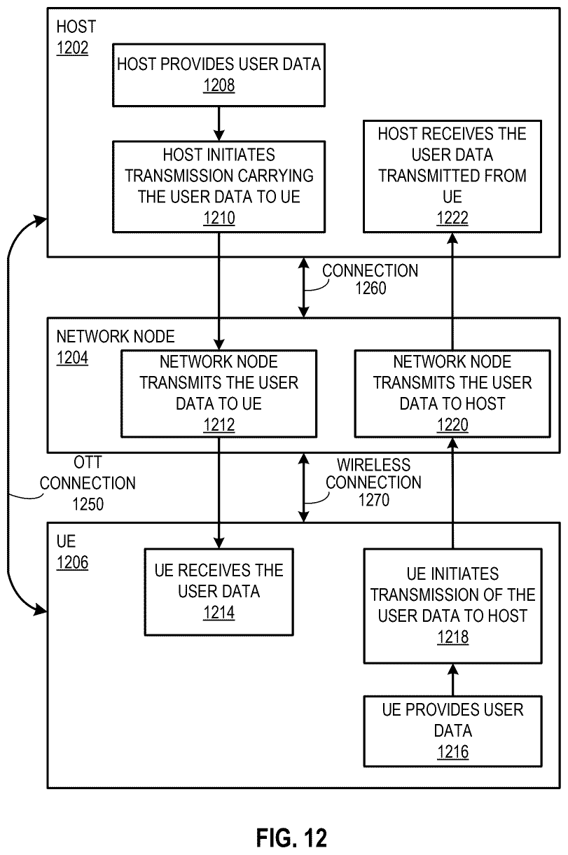

FIG. 12 shows a communication diagram of a host 1202 communicating via a network node 1204 with a UE 1206 over a partially wireless connection in accordance with some embodiments. Example implementations, in accordance with various embodiments, of the UE (such as a UE 712a of FIG. 7 and/or UE 800 of FIG. 8), network node (such as network node 710a of FIG. 7 and/or network node 900 of FIG. 9), and host (such as host 716 of FIG. 7 and/or host 1000 of FIG. 10) discussed in the preceding paragraphs will now be described with reference to FIG. 12.

Like host 1000, embodiments of host 1202 include hardware, such as a communication interface, processing circuitry, and memory. The host 1202 also includes software, which is stored in or accessible by the host 1202 and executable by the processing circuitry. The software includes a host application that may be operable to provide a service to a remote user, such as the UE 1206 connecting via an over-the-top (OTT) connection 1250 extending between the UE 1206 and host 1202. In providing the service to the remote user, a host application may provide user data which is transmitted using the OTT connection 1250.

The network node 1204 includes hardware enabling it to communicate with the host 1202 and UE 1206. The connection 1260 may be direct or pass through a core network (like core network 706 of FIG. 7) and/or one or more other intermediate networks, such as one or more public, private, or hosted networks. For example, an intermediate network may be a backbone network or the Internet.

The UE 1206 includes hardware and software, which is stored in or accessible by UE 1206 and executable by the UE's processing circuitry. The software includes a client application, such as a web browser or operator-specific “app” that may be operable to provide a service to a human or non-human user via UE 1206 with the support of the host 1202. In the host 1202, an executing host application may communicate with the executing client application via the OTT connection 1250 terminating at the UE 1206 and host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via a connection 1260 between the host 1202 and the network node 1204 and via a wireless connection 1270 between the network node 1204 and the UE 1206 to provide the connection between the host 1202 and the UE 1206. The connection 1260 and wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204, in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

One or more of the various embodiments improve the performance of OTT services provided to the UE 1206 using the OTT connection 1250, in which the wireless connection 1270 forms the last segment. More precisely, the teachings of these embodiments may improve the signalling overhead of the network and thereby provide benefits such as increased network availability and reduced user waiting time.

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR or AR which it can broadcast, multicast or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1250 between the host 1202 and UE 1206, in response to variations in the measurement results. The measurement procedure and/or the network functionality for reconfiguring the OTT connection may be implemented in software and hardware of the host 1202 and/or UE 1206. In some embodiments, sensors (not shown) may be deployed in or in association with other devices through which the OTT connection 1250 passes; the sensors may participate in the measurement procedure by supplying values of the monitored quantities exemplified above, or supplying values of other physical quantities from which software may compute or estimate the monitored quantities. The reconfiguring of the OTT connection 1250 may include message format, retransmission settings, preferred routing etc.; the reconfiguring need not directly alter the operation of the network node 1204. Such procedures and functionalities may be known and practiced in the art. In certain embodiments, measurements may involve proprietary UE signaling that facilitates measurements of throughput, propagation times, latency and the like, by the host 1202. The measurements may be implemented in that software causes messages to be transmitted, in particular empty or ‘dummy’ messages, using the OTT connection 1250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method performed by a user equipment, UE, in a wireless communication network, comprising:
receiving a configured grant, CG, configuration, wherein a plurality of transmission occasions, TOs, are referenced in the CG configuration;
transmitting to a network node an unused TO, UTO, indicator for the CG configuration that indicates that one or more of the TOs referenced in the CG configuration will be unused;
transmitting to the network node an indicator that indicates a time window during which the UTO indicator is valid; and
transmitting to the network node an uplink signal during a TO referenced in the CG configuration in accordance with the UTO indicator during the time window.

2. The method of claim 1, wherein the time window is indicated as [T+W1, T+W2], where T is a reference time and 0<=W1<=W2.

3. The method of claim 1, wherein the reference time comprises a time when the indicator that indicates the time window is transmitted.

4. The method of claim 1, wherein the reference time is indicated with the indicator that indicates the time window.

5. The method of claim 1, wherein the time window is configured by the network node.

6. The method of claim 1, wherein the time window is selected or altered by the UE.

7. The method of claim 1, wherein the UTO indicator comprises a bitmap of TOs referenced in the CG configuration.

8. The method of claim 1, further comprising:
providing user data; and
forwarding the user data to a host via the transmission to the network node.

9. A user equipment, comprising:
processing circuitry configured to perform operations comprising to:
receive a configured grant, CG, configuration, wherein a plurality of transmission occasions, TOs, are referenced in the CG configuration,
transmit to a network node an unused TO, UTO, indicator for the CG configuration that indicates that one or more of the TOs referenced in the CG configuration will be unused,
transmit to the network node an indicator that indicates a time window during which the UTO indicator is valid, and
transmit to the network node an uplink signal during a TO referenced in the CG configuration in accordance with the UTO indicator during the time window; and
power supply circuitry configured to supply power to the processing circuitry.

10. A method performed by a network node in a wireless communication network, comprising:
configuring a user equipment, UE, with a configured grant, CG, configuration, wherein a plurality of transmission occasions, TOs, are referenced in the CG configuration;
receiving from the UE an unused TO, UTO, indicator for the CG configuration that indicates that one or more of the TOs referenced in the CG configuration will be unused;
receiving from the UE an indicator that indicates a time window during which the UTO indicator is valid; and
receiving from the UE an uplink signal during a TO referenced in the CG configuration in accordance with the UTO indicator during the time window.

11. The method of claim 10, wherein the time window is indicated as [T+W1, T+W2], where T is a reference time and 0<=W1<=W2.

12. The method of claim 10, wherein the reference time comprises a time when the indicator that indicates the time window is transmitted.

13. The method of claim 10, wherein the reference time is indicated with the indicator that indicates the time window.

14. The method of claim 10, wherein the time window is configured by the network node.

15. The method of claim 10, wherein the time window is selected or altered by the UE.

16. The method of claim 10, wherein the UTO indicator comprises a bitmap of TOs referenced in the CG configuration.

17. The method of claim 10, further comprising:
obtaining user data; and
forwarding the user data to a host or a user equipment.

18. A network node, the network node comprising:
processing circuitry configured to perform operations comprising to:
configure a user equipment, UE, with a configured grant, CG, configuration, wherein a plurality of transmission occasions, TOs, are referenced in the CG configuration,
receive from the UE an unused TO, UTO, indicator for the CG configuration that indicates that one or more of the TOs referenced in the CG configuration will be unused,
receive from the UE an indicator that indicates a time window during which the UTO indicator is valid, and
receive from the UE an uplink signal during a TO referenced in the CG configuration in accordance with the UTO indicator during the time window; and
power supply circuitry configured to supply power to the processing circuitry.
